(19) United States
(12) Patent Application Publication
(10) Pub. No.: US 2026/0203615 A1
(43) Pub. Date: Jul. 16, 2026

(54) BUFFERS SQUEEZING AND SOURCE CODE SYNTHESIS FOR REDUCED INFERENCE COST ON RESOURCE-CONSTRAINED SYSTEMS

(71) Applicant: QUALCOMM Incorporated, San Diego, CA (US)

(72) Inventor: Haijun ZHAO, Beijing (CN)

(21) Appl. No.: 19/137,249

(22) PCT Filed: Feb. 1, 2023
(86) PCT No.: PCT/CN2023/074100

§ 371 Date: Jun. 9, 2025

(51) Int. Cl. G06N 5/04

(52) U.S. Cl. CPC G06N 5/04

(57) ABSTRACT

A processor-implemented method for performing inference tasks on resource limited device include receiving, by an artificial neural network (ANN), an input. The ANN includes one or more fused layers. The input is processed using the one or more fused layers to generate a fused output. The ANN generates an inference using the fused output.

### BACKGROUND

### Field Aspects of the present disclosure generally relate to processing of convolutional computations.

### Background

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, pattern recognition, speech recognition, autonomous driving, and other classification tasks.

Deep neural networks have greatly improved streaming data (e.g., image, video, inertial measurement unit (IMU) data, and WiFi) classification performance. It is desirable to incorporate such networks with Internet of things (IoT) devices, smartphones, or other low power devices that stream data. Unfortunately, the extensive resources consumed for classification due to the amount of computation involved makes it challenging to utilize deep neural networks on real-time, energy-sensitive applications.

### SUMMARY

The present disclosure is set forth in the independent claims, respectively. Some aspects of the disclosure are described in the dependent claims.

In one aspect of the present disclosure, a processor-implemented method includes receiving, by an artificial neural network (ANN), an input, the ANN including one or more fused layers. The method further includes processing the input using the one or more fused layers to generate a fused output. The method still further includes generating, by the ANN, an inference using the fused output.

Another aspect of the present disclosure is directed to an apparatus including means for receiving, by an artificial neural network (ANN), an input, the ANN including one or more fused layers. The apparatus further includes means for processing the input using the one or more fused layers to generate a fused output. The apparatus still further includes means for generating, by the ANN, an inference using the fused output.

In another aspect of the present disclosure, a non-transitory computer-readable medium with non-transitory program code recorded thereon is disclosed. The program code is executed by a processor and includes program code to receive, by an artificial neural network (ANN), an input, the ANN including one or more fused layers. The program code further includes program code to process the input using the one or more fused layers to generate a fused output. The program code still further includes program code to generate, by the ANN, an inference using the fused output.

Another aspect of the present disclosure is directed to an apparatus having a memory and one or more processors coupled to the memory. The processor(s) is configured to receive, by an artificial neural network (ANN), an input, the ANN including one or more fused layers. The processor(s) is further configured to process the input using the one or more fused layers to generate a fused output. The processor(s) is still further configured to generate, by the ANN, an inference using the fused output.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating an exemplary deep convolutional network (DCN), in accordance with aspects of the present disclosure.

FIG. 3 is a block diagram illustrating an exemplary deep convolutional network (DCN), in accordance with aspects of the present disclosure.

FIG. 4 is a block diagram illustrating an exemplary software architecture that may modularize artificial intelligence (AI) functions, in accordance with aspects of the present disclosure.

FIG. 5 is a block diagram illustrating adapting an architecture for an artificial neural network (ANN) using buffer squeezing, in accordance with aspects of the present disclosure.

FIGS. 6A and 6B are diagrams showing an example source code for executing conventional convolutional layer and source code for executing example architecture, respectively, in accordance with aspects of the present disclosure.

FIG. 7 is a flow diagram illustrating a processor-implemented method for generating an inference on a resource constrained device code, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Deep neural networks (DNNs) have greatly improved streaming data (e.g., image, video, inertial measurement unit (IMU) data, and Wi-Fi) classification performance. It is desirable to incorporate such networks with Internet of things (IoT) devices, smartphones, or other low power devices for streaming data. Unfortunately, the extensive resources consumed for classification due to the amount of computation involved makes it challenging to utilize DNNs on real-time, energy-sensitive applications on low power systems, such as central processing units (CPUs), digital signal processors (DSPs), reduced instruction set computer (RISC) processors, microcontroller units (MCUs), and similar systems.

The memory system is one determinant of performance and energy consumption. That is, memory access is a significant cost for both energy and price for existing resource constrained low power systems, such as a central processing unit (CPU), digital signal processor (DSP), reduced instruction set computer (RISC) processor, a microcontroller unit (MCU), or the like. Increasing the memory size may also result in increased power consumption and poor data locality, which may, in turn, lead to increased cache misses and memory traffic. Many deep neural network computations occur in the convolution kernel, which involves the matrix multiplication of inputs and weights. One common implementation of convolutional kernels is the general matrix multiply algorithm. However, a general matrix multiply (GEMM)-based convolution layer implementation uses additional memory space (e.g., C=H×W×K², where K is the kernel size, C is the channel size, H is the height, and W is the weight), which again may be problematic.

Computer programming loops also play an important role in increasing execution speed and reducing overhead for scientific computational kernels, (e.g., a one-dimensional (1D), two-dimensional (2D), or three-dimensional (3D) convolutional kernel). Loops are programming structures that repeat a sequence of instructions until a condition is met. However, compilers may be inefficient for optimization of nested loops, which are programming structures in which one or more loops are included within another loop.

On resource constrained systems, such as mobile devices or Internet of Things (IoT) devices, for example, a significant portion of a memory footprint for convolutional neural networks is for buffers of inputs, outputs, and weights.

To address these and other challenges, aspects of the present disclosure are directed to reducing inference cost in artificial neural network using buffer squeezing. In accordance with aspects of the present disclosure, a conventional neural network architecture that includes a separate convolution layer, a separate activation layer (e.g., a rectifier linear unit (ReLU) layer) and a separate max pooling layer, may be replaced by an architecture including a merged or fused convolution, max pooling and activation layer (e.g., ReLU). Buffer squeezing may be used to generate the fused convolution, ReLU and pooling layer. Buffer squeezing may refer to removing a layer of output buffers and merging the output buffers of two or more layers. For example, convolution layer output buffers, which account for a significant portion of a memory footprint, may be removed to address memory size and access challenges. Additionally, in some aspects, nested loops may be transformed to mix instructions from different layers and the instructions may be rescheduled for the compiler.

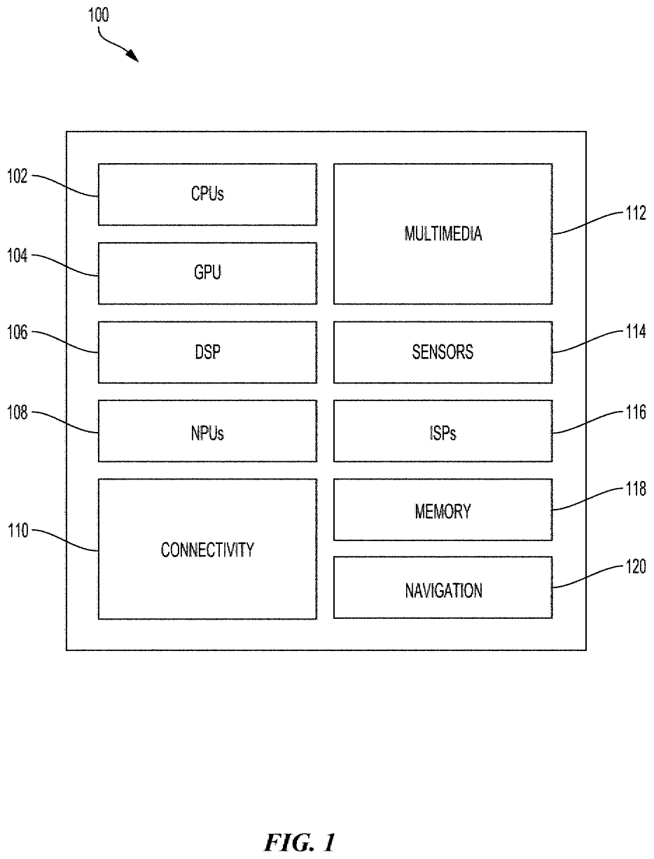

FIG. 1 illustrates an example implementation of a system-on-a-chip (SOC) 100, which may include a central processing unit (CPU) 102 or a multi-core CPU configured for performing inference tasks for resource constrained systems. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive, by an artificial neural network (ANN), an input, the ANN including one or more fused layers. The general-purpose processor 102 may also include code to process the input using the one or more fused layers to generate a fused output. In addition, the general-purpose processor 102 may include code to generate, by the ANN, an inference using the fused output.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

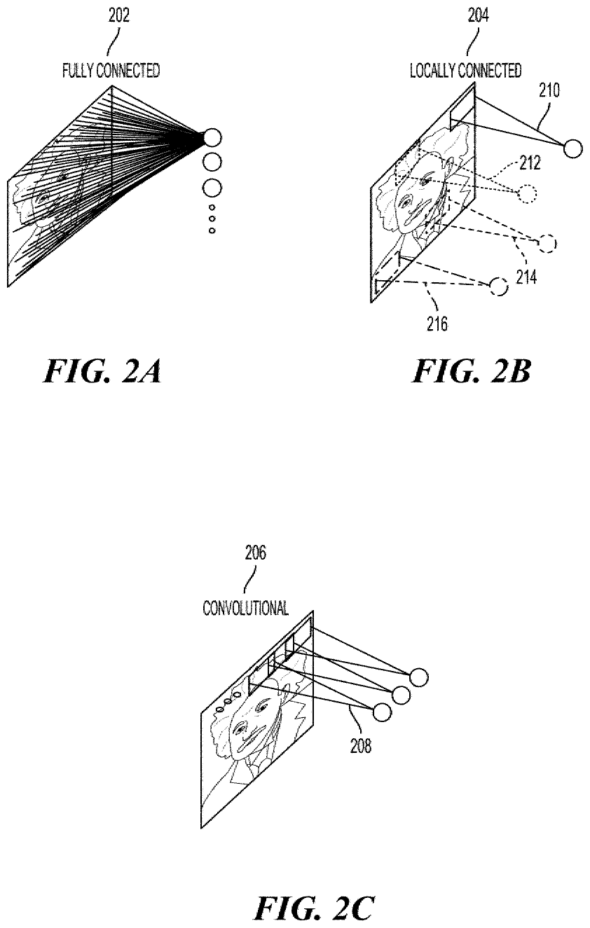

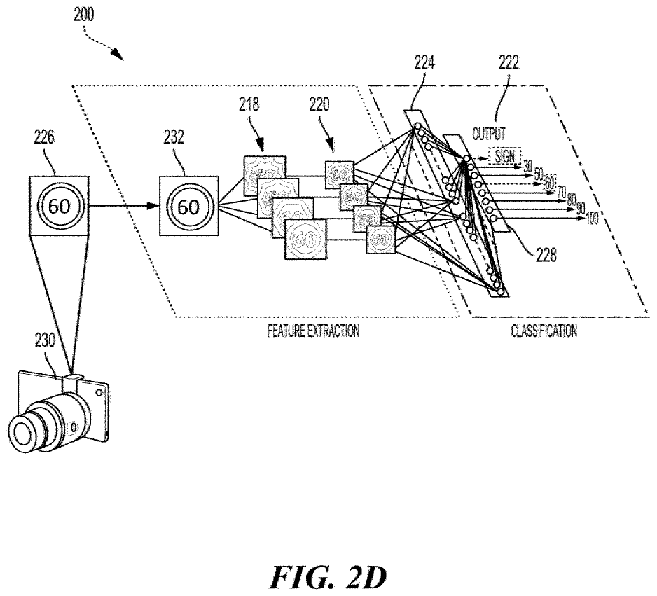

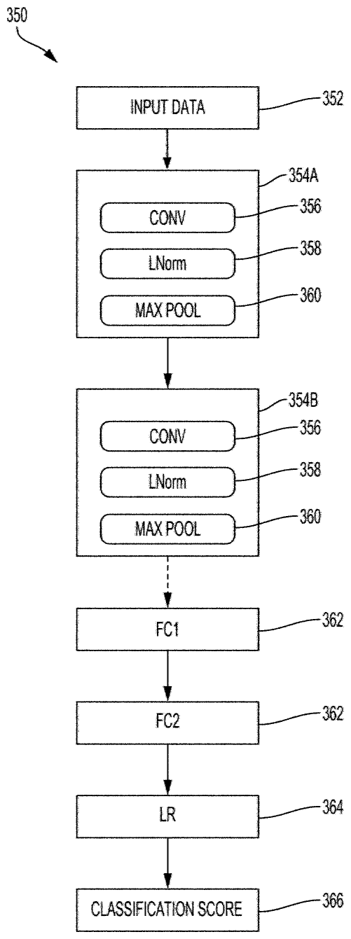

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206.

The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

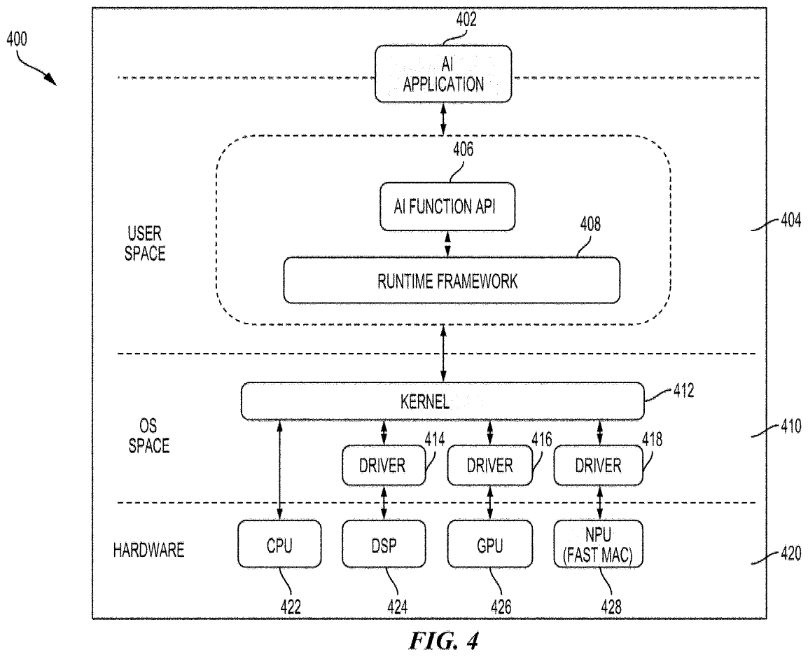

FIG. 4 is a block diagram illustrating an exemplary software architecture 400 that may modularize artificial intelligence (AI) functions. Using the architecture, applications may be designed that may cause various processing blocks of an SOC 420 (for example a CPU 422, a DSP 424, a GPU 426 and/or an NPU 428) to support adaptive rounding as disclosed for post-training quantization for an AI application 402, according to aspects of the present disclosure.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an Al function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine, for example, to request an inference at a particular time interval or triggered by an event detected by the user interface of the application. When caused to provide an inference response, the run-time engine may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The application 402 (e.g., an AI application) may be configured to call functions defined in a user space 404 that may, for example, provide for the detection and recognition of a scene indicative of the location in which the device currently operates. The application 402 may, for example, configure a microphone and a camera differently depending on whether the recognized scene is an office, a lecture hall, a restaurant, or an outdoor setting such as a lake. The application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the differential neural network may be configured to run on a combination of processing blocks, such as a CPU 422 and a GPU 426, or may be run on an NPU 428.

As described, aspects of the present disclosure are directed to reducing inference cost in artificial neural network using buffer squeezing. In accordance with aspects of the present disclosure, a conventional neural network architecture that includes a separate convolution layer, a separate activation layer (e.g., a rectifier linear unit (ReLU) layer) and a separate max pooling layer, may be replaced by an architecture including a merged or fused convolution, activation and pooling layer. Buffer squeezing may be used to generate the fused convolution, activation and pooling layer.

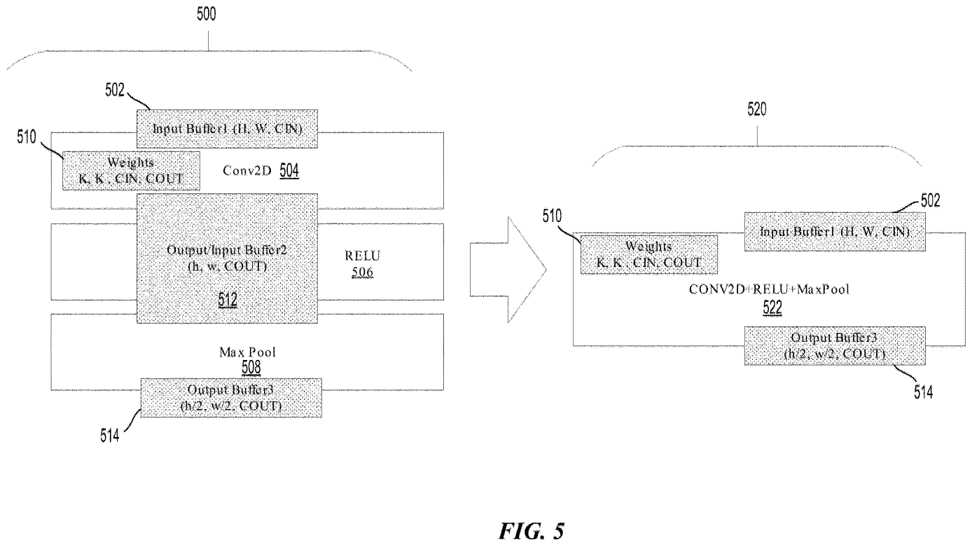

FIG. 5 is a block diagram illustrating adapting an architecture for an artificial neural network (ANN) using buffer squeezing, in accordance with aspects of the present disclosure. The artificial neural network may, for example, be a convolutional neural network. Referring to FIG. 5, an architecture for a conventional convolutional layer 500 is shown. The conventional convolutional layer 500 includes a separate convolution layer 504, a separate activation layer 506 (e.g., a ReLU layer) and a separate max pooling layer 508. The conventional convolutional layer 500 includes an input buffer 502, which supplies inputs to the convolution layer 504. The convolution layer 504 receives the inputs from the input buffer 502 and performs a convolution operation of the input and weights 510 to produce outputs, which are stored in the output buffer 512. The outputs of the convolution layer 504 serve as the inputs of the activation layer 506. In some aspects, the activation layer 506 may be a rectifier linear unit (ReLU), for example. The activation layer 506 retrieves the outputs of the convolution layer 504 from the output buffer 512. The activation layer 506 applies an activation function to the outputs of the convolution layer 504 and stores activation layer outputs in the output buffer 512. The activation layer output in the output buffer 512 are supplied as inputs of the max pooling layer 508. The max pooling layer 508 then generates an output that is stored in output buffer 514.

As described, one potential bottleneck of the conventional convolutional layer 500 is with respect to buffer size. In one example, the buffer size (e.g., output buffer 512) of a conventional convolutional layer 500 for a model size of 29.7 Kbytes may be 67.604 Kbytes-nearly three times the model size.

In accordance with aspects of the present disclosure, the conventional convolutional layer 500 may be transformed to generate an example architecture 520. As shown, The example architecture includes a fused convolution, activation, max pooling layer 522. That is, rather than the separate convolution layer 504, the separate activation layer 506 (e.g., a ReLU layer) and the separate max pooling layer 508 in the conventional convolutional layer 500, the example architecture replaces these separate layer with a fused (e.g., merged) convolution, activation, max pooling layer 522 (may be referred to as “fused layer 522”). The fused layer 522 may be generated by squeezing the buffers 512 and 514. For example, in some aspects, the output buffer 512 may be removed. By removing the output buffer 512, the memory footprint may be significantly reduced.

Additionally, instructions for the fused layer 522 may be generated using nested loop transformation to mix instructions from the previously separate layers (e.g., convolution layer 504, the activation layer 506 and the max pooling layer 508). Accordingly, the nested loop transforms may enable a compiler to reschedule instructions relative to an order for executing instructions for the conventional convolutional layer 500.

Additionally, it is noted that the example architecture 520 may comprise a portion of an artificial neural network (e.g., a layer). In some aspects, an artificial neural network (e.g., 350 of FIG. 3) may be configured such that each convolutional layer comprises the example architecture 520 or a subset of the artificial neural network layers.

Because the inputs of the input buffer 502 and weights 510 remain unchanged in the example architecture 520, the accuracy of the outputs of the example architecture 520 may likewise be substantially similar to or maintained with the accuracy of the conventional convolutional layer 500.

In some aspects, the example architecture 520 may be further modified to implement enhancements such as quantization and pruning to further improve processing speed of the corresponding artificial neural network.

For instance, in some aspects, nested loops may be transformed to mix instructions from different layers. Additionally, in some aspects, instructions may be rescheduled for the compiler.

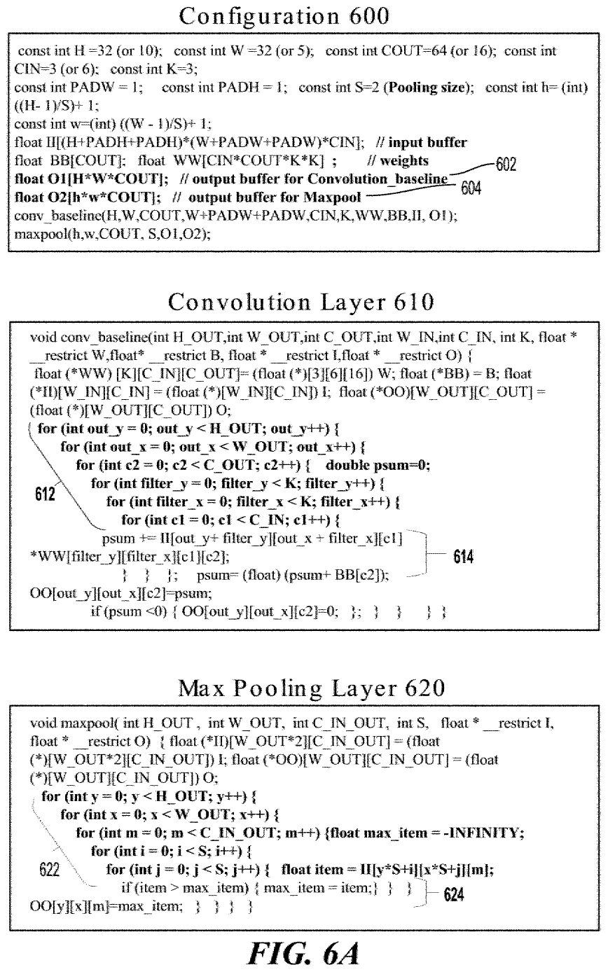

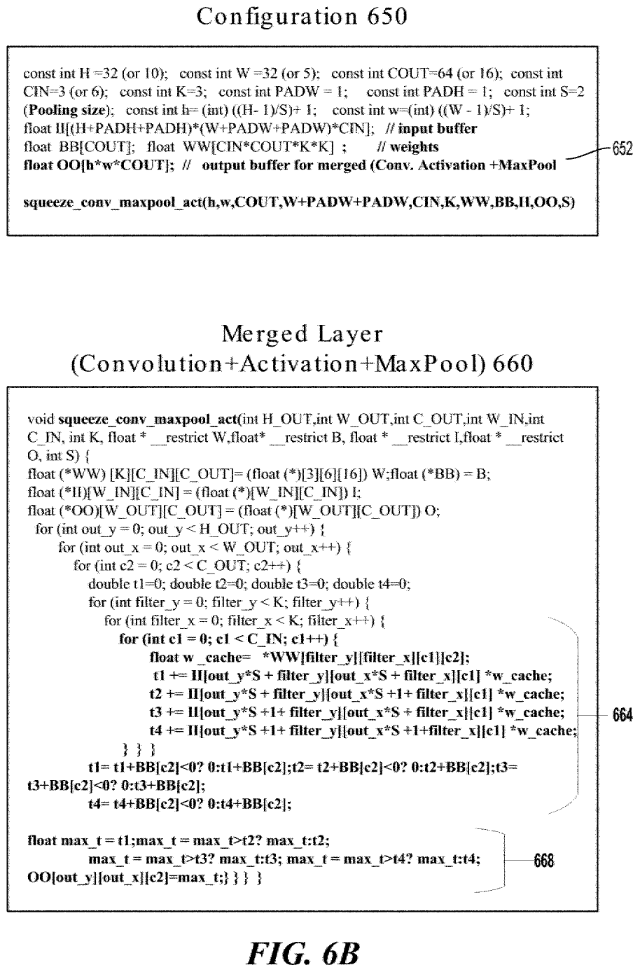

FIGS. 6A and 6B are diagrams showing an example source code for executing conventional convolutional layer 500 and source code for executing example architecture 520, respectively, in accordance with aspects of the present disclosure. As shown in FIG. 6A, example source code for executing the conventional convolutional layer 500 include a configuration block 600, a convolution layer block 610, and a max pooling layer block 620. The configuration block 600 includes configuration information for defining an output buffer 602 for the convolution layer and for defining an output buffer 604 for the max pooling layer of the artificial neural network. The convolution layer block 610 defines a function (conv_baseline) for performing a convolution operation of inputs and weights and accumulating partial sums (psum) 614 to generate outputs. The max pooling layer block 620 defines a function (maxpool) for determining a maximum value (max_item) 624 and assigning the maximum value 624 as an output. The convolution layer block 610 and max pooling layer block 620 utilize a similar structure for performing the respective functions. That is, both the convolution layer block 610 and max pooling layer block 620 include a set of nested loops (612, 622).

Referring to FIG. 6B, example source code for executing the example architecture 520 of FIG. 5. The example source code for executing the example architecture 520 may include a configuration block 650 and a fused layer block 660. The configuration block 600, convolution layer block 610, and max pooling layer block 620 may be transformed and replaced with a configuration block 650 and a fused layer block 660. In the configuration block 650, the configuration information (of FIG. 6A) defining output buffers (602, 604) may be replaced with the configuration information 652. That is, the output buffer (602) for the convolution layer block (610) is removed. Instead, the configuration block 650 includes only an output buffer 652, which may serve as an output buffer for a fused layer specified in the fused layer block 660.

In addition, the convolution layer block 610 and the max pooling layer block 620 are merged or fused and replaced by the fused layer block 660. Taking advantage of the similar structure of the convolution layer block 610 and the max pooling layer block 620, a nested loop transformation may be performed to mix instructions from the convolution layer block 610 and the max pooling layer block 620 to generate the fused layer block 660. The nested loop transformation may aid compilers in rescheduling instructions, which may improve other performance metrics (e.g., ticks, cycles, instructions, I/D cache load and save, L2 cache, L2 miss, etc.) The loop transformations may, for example, include loop reordering, unrolling, scalar register replacement or other transformations.

Loop unrolling is a loop transformation that attempts to optimize execution speed at the expense of memory size. Loop unrolling attempts to reduce loop overhead by increasing the number of instructions executed between branching operations. Loop unrolling involves adding program code for the loop to be performed multiple times within the loop body. That is, the loop body may be replicated a number of times based on the conditions provided in the loop definition. Scalar register replacement on the other hand, involves replacing repeated accesses to an array element with a temporary scalar value. Rather than accessing the array element in memory, the array element may be accessed via a register.

In the example of FIGS. 6A-6B, the code for computing the partial sums psum 614 in the convolution layer block 610 may be transformed (e.g., unrolled and scalar register replacement) and included in the fused layer block 660 as the code portion 664. The determination of the maximum value 624 of the max pooling layer block 620 may be transformed (e.g., unrolled) and incorporated in the fused layer block 660 as the code portion 668. By fusing or merging the convolution layer, activation layer, and max pooling layer as in the fused layer block 660, the memory footprint for the example architecture 520 may be significantly reduced in comparison with the memory footprint for the conventional convolutional layer 500 corresponding to separate blocks 610 and 620.

Accordingly, by executing the source code 650 and 660, an artificial neural network including one or more fused layer may be operated to perform inference tasks, for example. For instance, an input may be received by the artificial neural network. The input may comprise and sensor input or an image, for example.

In some aspects, the merging of the convolution layer, activation layer, and max pooling layer to produce the fused layer block 660 may be performed such that an accuracy level of the corresponding artificial neural network may be maintained. That is, the accuracy of the artificial neural network corresponding to blocks 600, 610, and 620 may be approximately equal to the accuracy of the artificial neural network corresponding to blocks 650 and 660. In some aspects, further enhancements such as quantization, pruning, or other model compression techniques may be implemented to further improve processing speed of the corresponding artificial neural network at the expense of some accuracy loss.

Accordingly, an artificial neural network including the fused layer 522 of FIG. 5 may be configured using the source code 660 of FIG. 6B. In some aspects, the artificial neural network may be implemented on a resource-limited device such as a mobile device or an IoT device.

In operation, an input may be received by the artificial neural network. The input may be stored in the input buffer 502. The input buffer 502 may be implemented using the configuration block 650. The input may be supplied to the fused layer 522. The fused layer 522 may execute a set of instruction to corresponding to the function of the convolution, activation and max pooling layer (shown in block 660 of FIG. 6B). The fused layer 522 may performing a convolution operation of inputs and weights and accumulating partial sums (e.g., t1-t4) in code block 664. The partial sums may be rectified the max pooled in code block 668 to generate a fused layer output. The output of fused layer 522 may be stored in output buffer 514. The output 514 may be supplied to a successive layers of the artificial network and may be used to compute an inference.

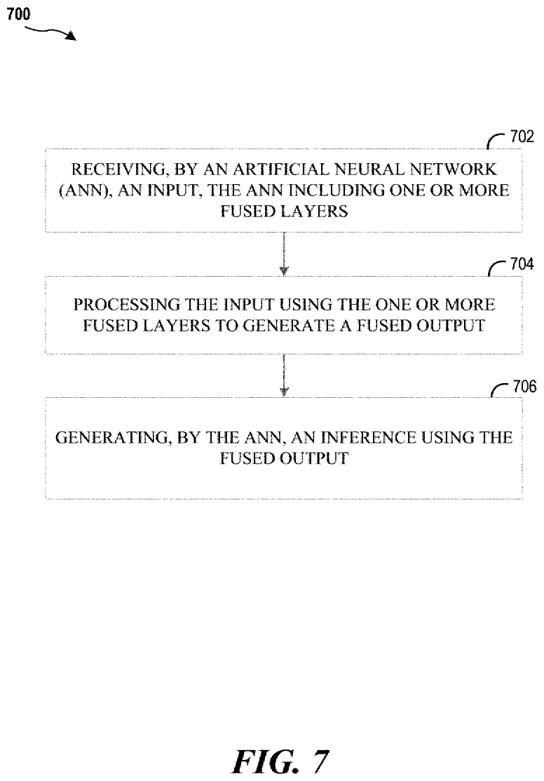

FIG. 7 is a flow diagram illustrating a processor-implemented method 700 for generating an inference on a resource constrained device code, in accordance with aspects of the present disclosure. The processor-implemented method 700 may be performed using a processor, such as CPU 102 or NPU 108 of FIG. 1, for example. As shown in FIG. 7, at block 702, the processor receives, by an artificial neural network (ANN), an input, the ANN including one or more fused layers. As described with reference to FIG. 6B, an input may be received by the artificial neural network. The input may, for instance, comprise a signal from a sensor or an image, for example.

The artificial neural network may, for example, be a convolutional neural network. For example, as described with reference to FIG. 5, the example architecture 520 may comprise a portion of an artificial neural network (e.g., a layer). In some aspects, an artificial neural network (e.g., 350 of FIG. 3) may be configured such that each convolutional layer comprises the example architecture 520 or a subset of the artificial neural network layers.

At block 704, the processor processes the input using the one or more fused layers to generate a fused output. As describe with reference to FIG. 6B, The input may be supplied to the fused layer 522. The fused layer 522 may execute a set of instruction to corresponding to the function of the convolution, activation and max pooling layer (shown in block 660 of FIG. 6B). The fused layer 522 may performing a convolution operation of inputs and weights and accumulating partial sums (e.g., t1-t4) in code block 664. The partial sums may be rectified the max pooled in code block 668 to generate a fused layer output. The output of fused layer 522 may be stored in output buffer 514.

At block 706, the processor generates, by the ANN, an inference using the fused output. As described with reference to FIG. 6B, the output 514 may be supplied to a successive layers of the artificial network and may be used to compute an inference.

In some aspects, the output source code 520 may be further modified to implement enhancements such as quantization, pruning, or model compression to tradeoff some model accuracy for increased processing speed of the corresponding artificial neural network.

Implementation examples are included in the following numbered clauses.

1. A processor-implemented method comprising:
receiving, by an artificial neural network (ANN), an input, the ANN including one or more fused layers;
processing the input using the one or more fused layers to generate a fused output; and
generating, by the ANN, an inference using the fused output.

2. The processor-implemented method of clause 1, in which the one or more fused layers executes a set of merged functions of a convolutional layer, an activation layer and a max pooling layer.

3. The processor-implemented method of clause 1 or 2, in which the ANN is operated using one of a mobile device or an Internet of Things (IoT) device.

4. The processor-implemented method of any of clauses 1-3, in which the ANN includes one or more of a convolutional layer, an activation layer or a max pooling layer.

5. An apparatus, comprising:
a memory; and
at least one processor coupled to the memory, the at least one processor configured:
to receive, by an artificial neural network (ANN), an input, the ANN including one or more fused layers;
to process the input using the one or more fused layers to generate a fused output; and
to generate, by the ANN, an inference using the fused output.

6. The apparatus of clause 5, in which the one or more fused layers execute a set of merged functions of a convolutional layer, an activation layer and a max pooling layer.

7. The apparatus of clause 5 or 6, in which the ANN is operated using one of a mobile device or an Internet of Things (IoT) device.

8. The apparatus of any of clauses 5-7, in which the ANN includes one or more of a convolutional layer, an activation layer or a max pooling layer.

9. A non-transitory computer-readable medium having program code recorded thereon, the program code executed by a processor and comprising:
program code to receive, by an artificial neural network (ANN), an input, the ANN including one or more fused layers;
program code to process the input using the one or more fused layers to generate a fused output; and
program code to generate, by the ANN, an inference using the fused output.

10. The non-transitory computer-readable medium of clause 9, in which the one or more fused layers executes a set of merged functions of a convolutional layer, an activation layer and a max pooling layer.

11. The non-transitory computer-readable medium of clause 9 or 10, in which the ANN is operated using one of a mobile device or an Internet of Things (IoT) device.

12. The non-transitory computer-readable medium of any of clauses 9-11, in which the ANN includes a convolutional layer, an activation layer or a max pooling layer.

13. An apparatus, comprising:
means for receiving, by an artificial neural network (ANN), an input, the ANN including one or more fused layers;
means for processing the input using the one or more fused layers to generate a fused output; and
means for generating, by the ANN, an inference using the fused output.

14. The apparatus of clause 13, in which the one or more fused layers executes a set of merged functions of a convolutional layer, an activation layer and a max pooling layer.

15. The apparatus of clause 13 or 14, in which the ANN is operated using one of a mobile device or an Internet of Things (IoT) device.

16. The apparatus of any of clauses 13-15, in which the ANN includes one of more of a convolutional layer, an activation layer or a max pooling layer.

In some aspects, the receiving means, processing means, and/or generating means may be the CPU 102, program memory associated with the CPU 102, DSP 106, NPU 108, fully connected layers 362, NPU 428 and or the routing connection processing unit 216 configured to perform the functions recited. In other configurations, the aforementioned means may be any module or any apparatus configured to perform the functions recited by the aforementioned means.

Implementation examples are described in the following numbered clauses:
The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A processor-implemented method comprising:
receiving, by an artificial neural network (ANN), an input, the ANN including one or more fused layers;
processing the input using the one or more fused layers to generate a fused output; and
generating, by the ANN, an inference using the fused output.

2. The processor-implemented method of claim 1, in which the one or more fused layers executes a set of merged functions of a convolutional layer, an activation layer and a max pooling layer.

3. The processor-implemented method of claim 1, in which the ANN is operated using one of a mobile device or an Internet of Things (IoT) device.

4. The processor-implemented method of claim 1, in which the ANN includes one or more of a convolutional layer, an activation layer or a max pooling layer.

5. An apparatus, comprising:
a memory; and
at least one processor coupled to the memory, the at least one processor configured:
to receive, by an artificial neural network (ANN), an input, the ANN including one or more fused layers;
to process the input using the one or more fused layers to generate a fused output; and
to generate, by the ANN, an inference using the fused output.

6. The apparatus of claim 5, in which the one or more fused layers execute a set of merged functions of a convolutional layer, an activation layer and a max pooling layer.

7. The apparatus of claim 5, in which the ANN is operated using one of a mobile device or an Internet of Things (IoT) device.

8. The apparatus of claim 5, in which the ANN includes one or more of a convolutional layer, an activation layer or a max pooling layer.

9-12. (canceled)

13. An apparatus, comprising:
means for receiving, by an artificial neural network (ANN), an input, the ANN including one or more fused layers;
means for processing the input using the one or more fused layers to generate a fused output; and
means for generating, by the ANN, an inference using the fused output.

14. The apparatus of claim 13, in which the one or more fused layers executes a set of merged functions of a convolutional layer, an activation layer and a max pooling layer.

15. The apparatus of claim 13, in which the ANN is operated using one of a mobile device or an Internet of Things (IoT) device.

16. The apparatus of claim 13, in which the ANN includes one of more of a convolutional layer, an activation layer or a max pooling layer.
